(19) United States
(12) Patent Application Publication
(10) Pub. No.: US 2007/0233384 A1
(43) Pub. Date: Oct. 4, 2007

(54) METHOD AND SYSTEM FOR OFF-BOARD NAVIGATION WITH A PORTABLE DEVICE

(75) Inventor: Choy Wai Lee, Olathe, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., George Town (KY)

(21) Appl. No.: 11/560,895

(22) Filed: Nov. 17, 2006

Related U.S. Application Data
(63) Continuation-in-part of application No. 11/215,868, filed on Aug. 31, 2005.

(51) Int. Cl. G01C 21/00

(52) U.S. Cl. 701/213; 701/200

(57) ABSTRACT

A wireless portable device that includes a screen, a wireless antenna, transmitter and receiver for communicating over a wireless network with a remote server, a GPS antenna and receiver for receiving GPS signals from GPS satellites, a processor controlling communication over the wireless network and processing the GPS signals, memory storing a navigator application that utilizes the GPS signals and a client program. The client program includes a hypertext markup language (HTML) or scripting language interpreter that is configured to receive a file including hyperlinks from a server, render the file on the screen of the wireless portable device, recognize tags associated with a hyperlink, including either location information, geocode or both, and use the tags to initiate the navigator application.

### CROSS REFERENCE TO RELATED APPLICATION

This application is a continuation-in-part, and claims priority benefit, of U.S. patent application Ser. No. 11/215,868, filed Aug. 31, 2005, and entitled “Method and system for off-board navigation with a portable device,” which is hereby incorporated by reference in its entirety.

### BACKGROUND OF THE INVENTION

The present invention is generally related to methods and apparatus for off-board navigation, and more particularly, to navigation utilizing a portable device and remote network server.

Today, systems exist that offer real-time interactive distributed navigation through the use of a wireless device. The wireless device communicates over a wireless carrier to a remote server that performs various navigation related functions and returns navigation information to the wireless device for review by an operator.

However, distributed navigation systems have a somewhat limited feature set and offer limited functions. Conventional distributed navigation systems have a user interface that is awkward and less than user friendly. Also, the amount of navigation information related to a particular operation often may be quite large. As the amount of navigation information increases, it exceeds the storage capacity of the wireless device and introduces an additional delay during operation while large amounts of navigation information are being conveyed to the wireless device.

A need remains for an improved distributed navigation system. It is an object of certain embodiments to address the above and other needs of distributed wireless systems and methods.

### BRIEF DESCRIPTION OF THE INVENTION

In one aspect, some configurations of the present invention therefore provide a client program configured to be stored in a memory in a wireless portable device. The client program includes a hypertext markup language (HTML) or scripting language interpreter that is configured to receive a file including hyperlinks from a server, render the file on a screen of a wireless portable device, recognize tags associated with a hyperlink, including either location information, geocode or both, and use the tags to initiate a navigator application.

In another aspect, some configurations of the present invention provide a wireless portable device. The wireless portable device includes a screen, a wireless antenna, transmitter and receiver for communicating over a wireless network with a remote server, a GPS antenna and receiver for receiving GPS signals from GPS satellites, a processor controlling communication over the wireless network and processing the GPS signals, memory storing a navigator application that utilizes the GPS signals and a client program. The client program includes a hypertext markup language (HTML) or scripting language interpreter that is configured to receive a file including hyperlinks from a server, render the file on the screen of the wireless portable device, recognize tags associated with a hyperlink, including location information, geocode, or both, and use the tags to initiate the navigator application.

### BRIEF DESCRIPTION OF THE DRAWINGS

FIG. 1 illustrates a pictorial representation of a global positioning system (GPS) utilized with an embodiment of the present invention.

FIG. 2 illustrates a block diagram of an off-board distributed navigation system formed in accordance with an embodiment of the present invention.

FIG. 3 illustrates an exemplary portable wireless device operated in accordance with an embodiment of the present invention.

FIG. 4 illustrates a block diagram of the electronic components of a portable device formed in accordance with an embodiment of the present invention.

FIG. 5 illustrates a point of interest menu structure provided in accordance with an embodiment of the present invention.

FIG. 6 illustrates an address search menu structure provided in accordance with an embodiment of the present invention.

FIG. 7 illustrates a find name menu structure provided in accordance with an embodiment of the present invention.

FIG. 8 illustrates a find near-by points of interest menu structure provided in accordance with an embodiment of the present invention.

FIG. 9 illustrates a save location menu structure provided in accordance with an embodiment of the present invention.

FIG. 10 illustrates a find location menu structure provided in accordance with an embodiment of the present invention.

FIG. 11 illustrates a find friend menu structure provided in accordance with an embodiment of the present invention.

FIG. 12 illustrates a find near-by points of interest menu structure provided in accordance with an embodiment of the present invention.

FIG. 13 illustrates a flow chart for managing a local queue of the most recent waypoints in accordance with an embodiment of the present invention.

FIG. 14 illustrates a format of a web page provided in accordance with an embodiment of the present invention.

FIG. 15 illustrates a user interface screen flow provided in accordance with an embodiment of the present invention.

FIG. 16 illustrates an alternative screen flow provided in accordance with an embodiment of the present invention.

FIG. 17 illustrates a flow chart of processing operations carried out to manage storage of map data in cache in accordance with an embodiment of the present invention.

FIG. 18 illustrates a flow chart of processing operations carried out to facilitate data entry at the keypad in accordance with an embodiment of the present invention.

FIG. 19 illustrates a flow chart of processing operations carried out in accordance with an embodiment of the present invention.

FIG. 20 illustrates a block diagram of the electronic components of a portable device formed in accordance with an embodiment of the present invention.

FIG. 21 illustrates a block diagram of an off-board distributed navigation system formed in accordance with an embodiment of the present invention.

FIG. 22 illustrates a hypertext mark-up language page rendered by a client program formed in accordance with an embodiment of the present invention.

### DETAILED DESCRIPTION OF THE INVENTION

In the following detailed description, reference is made to the accompanying drawings which form a part hereof, and in which is shown, by way of illustration, specific embodiments in which the invention may be practiced. The embodiments are intended to describe aspects of the invention in sufficient detail to enable those skilled in the art to practice the invention. Other embodiments may be utilized and changes may be made without departing from the scope of the present invention. The following detailed description is, therefore, not to be taken in a limiting sense, and the scope of the present invention is defined only by the appended claims, along with the full scope of equivalents to which such claims are entitled.

The embodiments discussed hereafter are drawn to navigational systems and devices having navigation and route calculation capabilities. One type of navigational system includes Global Positioning Systems (GPS). Such systems are known and have a variety of uses. In general, GPS is a satellite-based radio navigation system capable of determining continuous position, velocity, time, and in some instances direction information for an unlimited number of users. Formally known as NAVSTAR, the GPS incorporates a plurality of satellites which orbit the earth in extremely precise orbits. Based on these precise orbits, GPS satellites can relay their location to any number of receiving units.

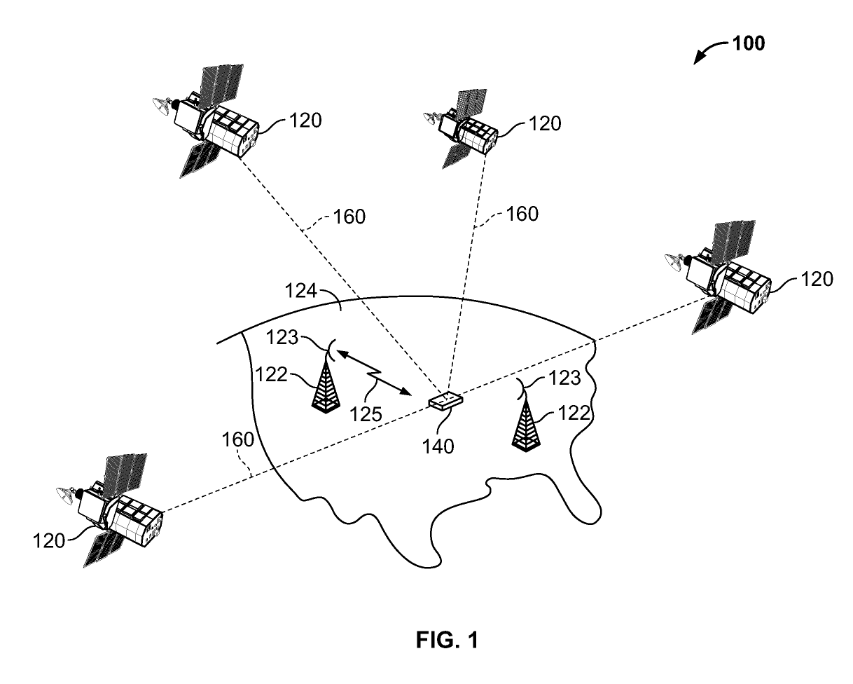

FIG. 1 is representative of a distributed off-board navigation network 100 that includes a plurality of satellites 120 arranged in orbit about the Earth 124. The orbit of each satellite 120 is not necessarily synchronous with the orbits of other satellites 120 and may be asynchronous. A GPS-enabled wireless device 140 is provided with a GPS receiver that scans radio frequencies for GPS signals 160 from the satellites 120. Upon receiving a radio signal from a GPS satellite 120, the device 140 determines the precise location of the satellite 120 via one of different conventional methods. The device 140 continues scanning for signals 160 until it has acquired at least three different satellite signals. Implementing geometric triangulation, the device 140 utilizes the three known satellite positions to determine the two-dimensional position of the device 140 relative to the satellites 120. Additionally, the device 140 may acquire a fourth satellite GPS signal 160 which will allow the device 140 to calculate the three-dimensional position of the device 140 by the same geometrical calculation. The positioning and velocity data can be updated in real time on a continuous basis by an unlimited number of users. The signals 160 are spread spectrum and continuously transmitted from each satellite 120 utilizing a highly accurate frequency standard accomplished with an extremely accurate atomic clock. Each satellite 120, as part of its data signal transmission, transmits a data stream indicative of that particular satellite 120.

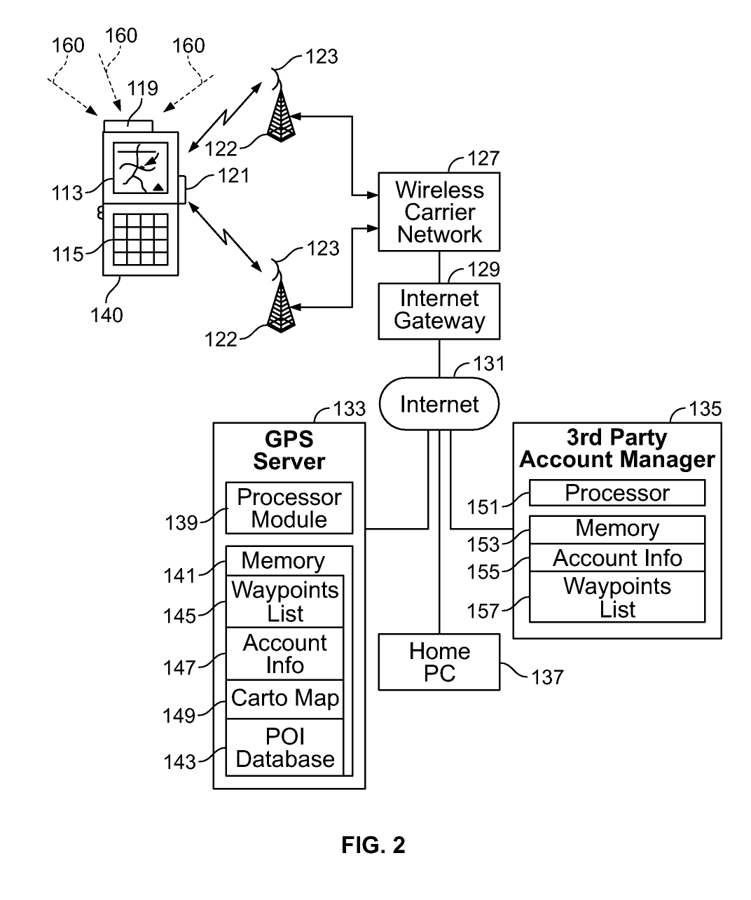

33 As shown in FIGS. 1 and 2, the device 140 also includes a wireless transmitter and receiver (transceiver) 121 that is configured to wirelessly communicate over bidirectional links 125 with towers 122. The device 140 includes a keypad 115 and a display 113. In FIG. 1, a series of towers 122 are provided that include transceivers 123 that transmit and receive over links 125 with the device 140. As shown in FIG. 2, the towers 122 are joined to one or more wireless carrier networks 127 that manage communications over the towers 122. The wireless carrier network 127 provides a link through an Internet gateway 129 to the Internet 131. A GPS server 133, a third-party account manager 135 and home PC 137 are examples of some of the types of devices joined to the Internet 131 and that may be utilized in connection with certain operations and functions described herein. The GPS server 133 may be managed by a GPS equipment provider (e.g., Garmin), while the third-party account manager may represent an Internet service provider (e.g. AOL, YAHOO and the like). One or both of the GPS server 133 and third-party account manager 135 maintain individual accounts for users that may include, among other things, stored lists of waypoints or points of interest, individualized categories, lists of points of interest organized by category and the like. The term “waypoint” shall be used to represent a “point of interest” when the POI is identified by a particular user as being of interest and saved in the users waypoint list.

34 The GPS server 133 includes a processor module 139 that manages individual user accounts, as well as performs navigation and routing operations based on requests from individual devices 140. The GPS server 133 also includes memory 141. The memory 141 stores, among other things, a cartographic map 149, a point of interest (POI) database 143, waypoint lists 145 and account information 147. The account information individually identifies each registered user. Each user account includes or has a unique link to a waypoint list 145 uniquely associated with an individual user. Each waypoint list includes a list of points of interest that have been identified by the user and saved in the user's individual account. The waypoint lists may be organized by category or alphabetically or both.

The third party account manager 139 includes a processor module 151 and memory 153. The memory 153 stores, among other things, individual account information 155 and waypoint lists 157 uniquely associated with each user. The waypoint lists 157 may be uniquely associated with each user and/or may be based on general categories.

In accordance with one off-board navigation process, the device 140 receives, at GPS antenna 119, GPS signals 160 from various satellites 120 and, based thereon, calculates the position of the device 140. The device 140 stores a navigation application that includes a navigation menu hierarchy or screen flow of screens, options, icons and text entry boxes. The hierarch defines a screen flow through which the device 140 sequences to complete various navigation-related operations. During menu-driven routing/mapping applications, the device 140 transmits its position information, a waypoint management instruction and/or a navigation information request over the wireless link 125 to a tower 122. The position information may simply include the satellite signals 160 received by the device 140 at a particular point in time. Alternatively, the device 140 may calculate a latitude and longitude coordinate combination representing the current position of the device 140, and transmit the latitude and longitude coordinate combination as the position information to the tower 122. The navigation information request may include a destination waypoint or point of interest and/or a request to calculate a route to the destination point of interest. Alternatively, the navigation information request may simply represent a request for a portion of the cartographic map for an area surrounding the device 140 and/or surrounding a point of interest. The navigation information request may also represent a selected item from an application menu (e.g. a selection of a category of POIs), text information or a list of potential matches. The navigation information request may also include a destination indicator identifying where the request should be routed by the wireless carrier network. Waypoint management instructions are utilized in connection with managing an individual user's account that is maintained by the GPS server 133 and/or a third party account manager 135. A waypoint management instruction may include information related to and/or identifying a particular point of interest, as well as a management instruction (e.g. rename, delete, copy, say, move, edit and the like).

The wireless carrier network 127 and Internet gateway 129 uniquely identify the device 140 and/or incoming navigation request, determine a destination corresponding to the GPS server 133 and/or the third-party account manager 135 and route the position information and navigation request to the corresponding destination. The destination may represent a statically or dynamically designated IP address and the like. The GPS server 133 and/or third-party account manager 135 store cartographic maps and have a large processing capability to perform computationally intensive navigation calculations. The GPS server 133 and/or third-party POIs account manager 135 receive the request, calculate or otherwise obtain the appropriate response, and convey reply navigation information over the Internet 131, Internet gateway 129, wireless carrier 127, and towers 122 to the device 140. The reply navigation information may include alphanumeric text (e.g., addresses, numbers, names, distance, and directions), a route from the present location of the device 140 to a destination point of interest, a clipped portion of map data surrounding the device 140 or surrounding a point of interest and the like. The GPS server 133 performs navigation functions and transmits calculated results and reply navigation information (e.g. text, a route, roadway map data, etc.) wirelessly to the device 140, thereby enabling the device 140 to become a navigation device.

The GPS server 133 stores a cartographic or map database that includes any number of locations and data indicative of thoroughfares of a plurality of types connecting certain ones of the locations. Different types of thoroughfares are contained in the data structure organized in a hierarchy of detail levels, or layers. The GPS server 133 utilizes a route calculation algorithm to find a path, or convergence, between any two locations in the data structure based on various criteria. For example, the criteria may include a number of jump segments requirement, a distance requirement, a minimum memory usage requirement, a maximum memory usage requirement, and the like. The criteria may be independently variable in order to tailor an aggressiveness with which the route calculation algorithm forces switching between different levels in the hierarchy of detail levels. Optionally, the hierarchy of detail levels may include a hierarchy of ever-decreasing detail levels such that a lowest level includes the greatest amount of detail. Any other suitable hierarchy of detail levels may be used.

In one embodiment, a type of thoroughfare in any given layer of the hierarchy of detail layers is determined by a traversability of the thoroughfare. For example, the traversability of the thoroughfare can be determined by the drivability of a road. Herein, the drivability of the road may be determined by the classification of the road, a speed classification of the road, a driving history on the road, and the like. However, the invention is not so limited and one of ordinary skill in the art will understand upon reading and comprehending this disclosure, that other criteria for determining the presence of a type of thoroughfare in any given layer of the hierarchy can be suited to the present invention.

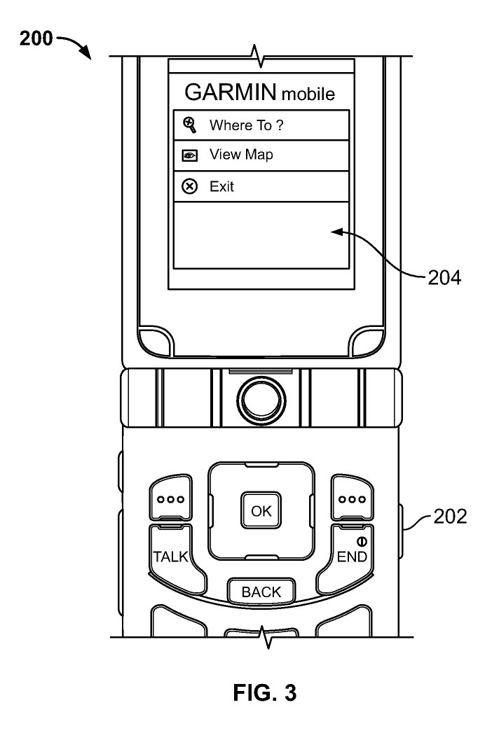

FIG. 3 illustrates a front plan view of a GPS equipped wireless device 200, such as a cell phone. The device 200 includes a user entry keypad 202 and a display 204. The device 200 includes a GPS antenna and GPS receiver that receives satellite signals from GPS satellites, and a wireless antenna and wireless receiver that bi-directionally communicate with a wireless network, such as a cellular telephone network. The display 204 outputs various types of information, such as roadway maps, menus, alphanumeric text, graphics, video, still images, pictures, routing information and the like.

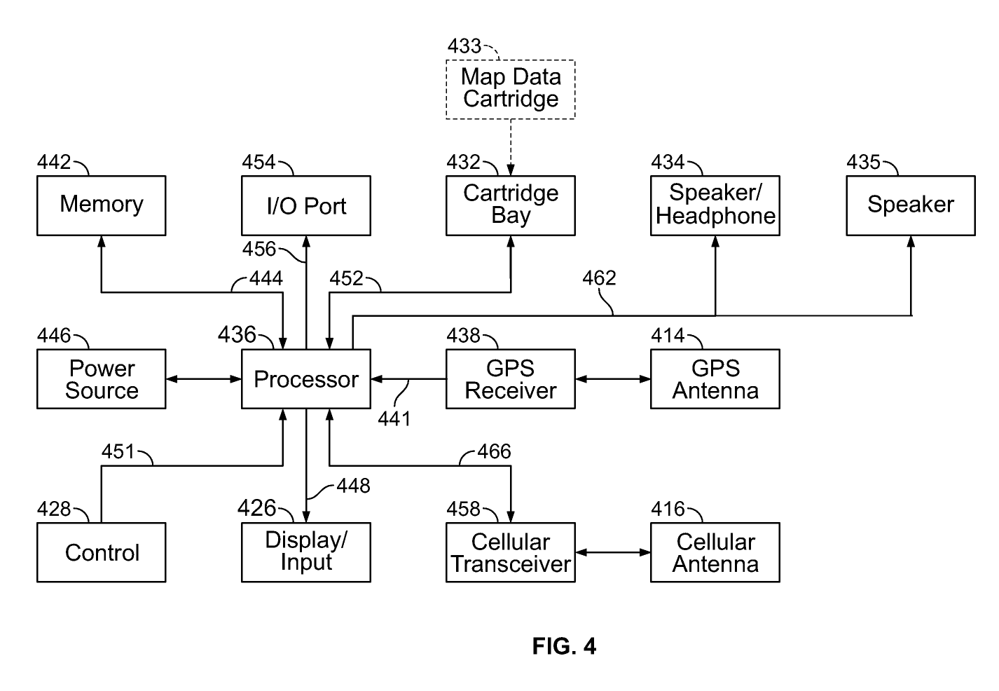

FIG. 4 illustrates a block diagram of one embodiment for the electronic components within the device 140 or 200. The electronic components include a processor 436 which is connected to a GPS antenna 414 through a GPS receiver 438 via line 441. The GPS antenna 414 is configured to receive GPS signals from satellites. The processor 436 interacts with an operating system (such as PalmOS; Pocket PC) that runs selected software depending on the intended use of the device 140 or 200. The processor 436 is coupled with a memory 442 such as RAM or CACHE via line 444, and a power source 446 for powering the electronic components of the device 140 or 200. The processor 436 calculates the present location (latitude, longitude and altitude) of the device 140 or 200 based on received GPS signals. The processor 436 operates a navigation application stored in the memory 442 as explained below. The processor 436 communicates with a display screen 426 via data line 448 to output the various types of information, such as roadway maps, menus, alphanumeric text, graphics, video, still images, pictures, routing information and the like. The display screen 426 is adapted to display all or part of the navigation information (e.g. roadway maps, addresses, names, phone numbers, real-time moving maps, simulated video advancement over a roadway network and the like) and menu structure or hierarchy (e.g. page layouts, page pixel formats, coloring, menu item names, forward and return links to other menu pages and the like).

The electronic components further include other input sources that are connected to the processor 436. Control buttons 428 are connected to the processor 436 via line 451. A map data cartridge 433 and/or a security card may be inserted into a cartridge bay 432 that is connected via line 452 to the processor 436. A conventional serial I/O port 454 is connected to the processor 436 via line 456. A cellular antenna 416 is connected to a cellular transceiver 458, which is connected to the processor 436 via line 466. The processor 436 is connected to a speaker/headphone jack 434 via line 462. Line 462 is also connected to a speaker 435 for playing audio navigation information. For example, the speaker 435 may output turn-by-turn directions, words or phrases and the like. The device may also include an infrared port (not shown) coupled to the processor 436 that may be used to transmit information from one device to another.

The memory 442 may be configured to store a navigation menu hierarchy or structure utilized by the user in connection with creating navigation requests and reviewing received navigation information. The menu structure also facilitates saving and using commonly accessed or favorite waypoints or POIs. The memory 442 also is configured to temporarily store at least portions of map data received over the wireless link 125 (FIG. 1) in response to a navigation request. The map data includes cartographic mapping information associated with a roadway network. In operation, the processor 436 accesses the menu structure and map data in connection with navigation operations. Optionally, the menu structure and map data may be stored in entirely separate memories or sections of memory. For example, the map data may be stored in cache, while the menu structure is stored in a more stable permanent memory, such as RAM or ROM.

In general, the menu hierarchy includes an interlinked collection or series of screens or pages that are stored in memory 442. Each page comprises options, text entry boxes, graphics windows, video windows, etc. The options may represent a function option, that directs the device to perform a function, or an item data option that is selectable by the user. Certain function options will direct the device to transmit wirelessly a navigation information request to a remote server. The menu hierarchy includes navigation pages (e.g. map pages, routing pages and the like) that are configured to present navigation information that is received wirelessly by the device from the remote server in response to the navigation information request. Examples of function options include GO, SAVE, NEARBY, VIEW MAP, CALL and the like.

When the GO option is selected, the application directs the portable device to transmit a navigation information request to the remote server 133. The navigation information request instructs the remote server 133 to perform a route calculation from a present location of the device to the selected POI. When the SAVE option is selected, the application directs the portable device to transmit a waypoint management instruction to the remote server 133. The waypoint management instruction directs the remote server 133 to save the selected POI as a waypoint in a waypoint list 145 associated with an individual user account 147. When a NEARBY option is selected, the application directs the portable device to transmit a navigation information request to the remote server 133. The navigation information request instructs the remote server 133 to return a NEARBY category list of categories for destination POIs that are near the selected POI. When the device represents a cellular phone and the CALL option is selected, the cellular phone automatically initiates a call to the selected POI. When the VIEW MAP option is selected, a map page is presented on the screen of the device. The map paging includes a roadway network surrounding the selected POI.

The GPS server 133 stores a point of interest relational database and a waypoint list of POIs of interest to the user. The POIs and waypoints are designated by name, address, latitude, longitude and categories. The GPS server 133 accesses and modifies the waypoint database 145 based on function and data options.

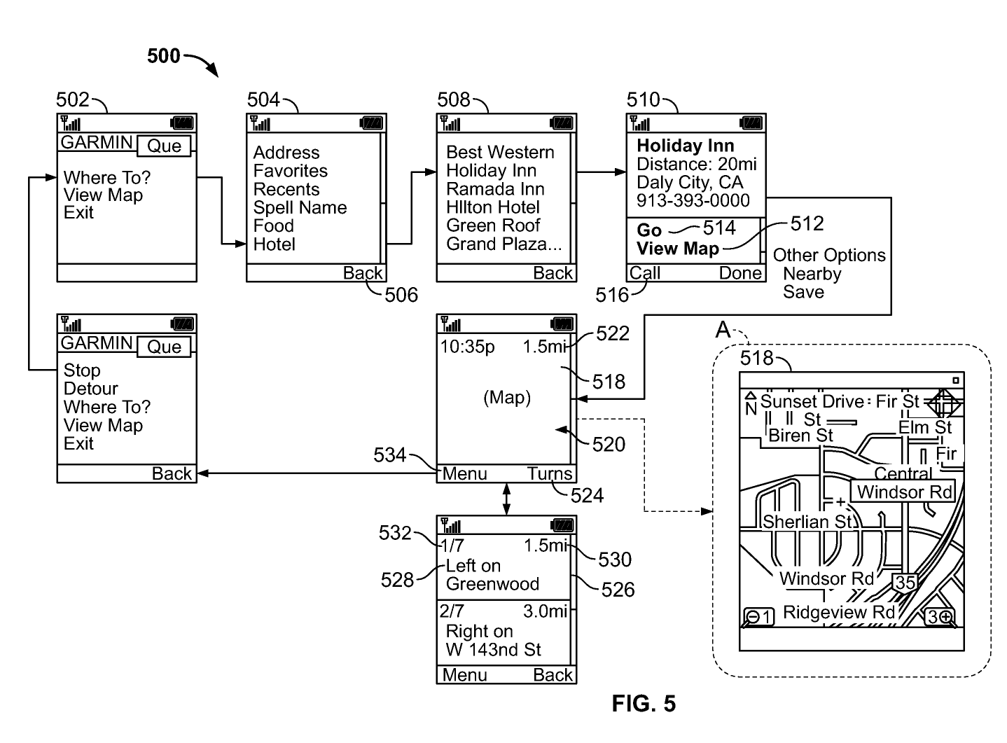

FIG. 5 illustrates a portion of a find POI screen flow or menu hierarchy 500 associated with finding a POI. A main menu page 502 allows the user to choose a “where to” function, a “view map” function, or an “exit” function. When the “where to” function is selected, a category screen or page 504 is obtained from memory 442 and displayed to allow the user to enter a particular “address”, GO to the user's individualized “favorites” list, view the most “recent” points of interest, “spell the name” of a particular point of interest, or select points of interest based on categories (e.g. food, hotel, transportation, commerce, business, medical and the like). A back icon or option 506 is provided to permit the user to move back to the prior main menu page 502. When the “hotel” category is selected from category page 504, a sub-category listing page 508 is presented with various hotels. The hotel list may be ordered alphabetically, based on individual user criteria, or based on the nearest hotels to the user's present location. Once a particular hotel is selected, POI address page 510 is presented with the name and address of the hotel, distance to the hotel, direction to the hotel, phone number and the like.

A “view map” option 512 and a GO option 514 are offered on the POI address page 510. When the “view map” option 512 is selected, the device 140, 200 wirelessly transmits a navigation request to the GPS server 133 to obtain roadway map data surrounding the point of interest. The roadway map data is displayed on the display 113, 204 of the device 140, 200. When the GO option 514 is selected, the device transits a navigation request to the GPS server 133 to obtain a route from the device's present location to the point of interest. The address page 510 also offers a “call” option 516 that, when selected, instructs the device 140, 200 to automatically dial the telephone number of the point of interest over the wireless link 125 and wireless carrier network 127. Further options may include permitting the operator to save the point of interest as a “favorite” in the user's individual favorites account.

FIG. 5 also illustrates a map page 518 that is presented once the VIEW MAP option is selected and a corresponding portion of a cartographic map is returned from the GPS server 133 (FIG. 1). The map page 518 is shown enlarged in area A and includes the roadway network surrounding the POI, along with a direction indicator 520, and a distance to the POI 522. A MENU option 534 permits the user to return to the main menu that now includes additional options, namely a STOP option and a DETOUR option. A TURNS option 524 is provided on map page 518 to obtain turn-by-turn instructions from the present location of the device to the POI. When the TURNS option 524 is selected, a turn-by-turn page 526 is presented including turn-by-turn text 528, a distance between each turn 530, and a turn-count indicator 532 identifying the total number of turns to the destination and the number of the present turn within the total number of turns (e.g. 1 of 7, 6 of 7, etc.). The user may manually scroll through the turn-by-turn text 528 with arrow keys on the keyboard. Optionally, the device may automatically scroll through the turn-by-turn text 528 as the device progresses along the route.

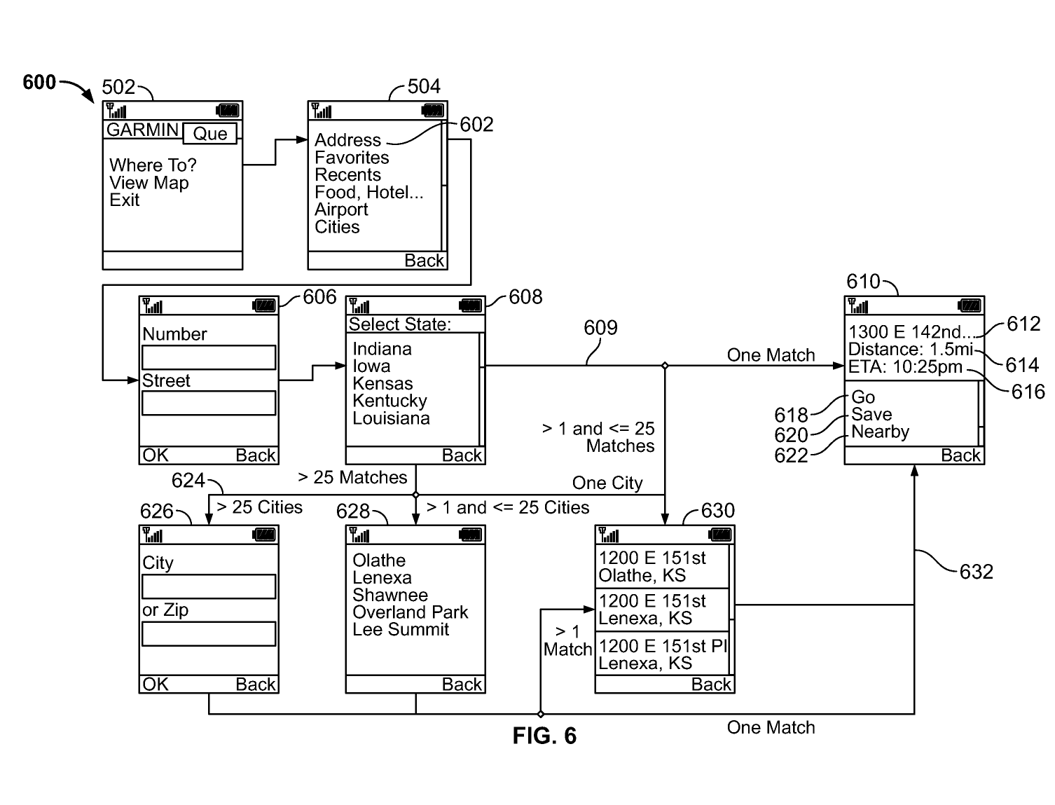

FIG. 6 illustrates an address search screen flow or menu hierarchy 600 that beginning at the main menu 502 and the category menu 504. When the address option 602 is selected from the category menu 504, an address data entry page 606 is presented. Once the user enters the address, a state listing page 608 is presented. Once the address and state are entered, the device transmits a navigation request, including the POI address and state, to the GPS server 133. Each navigation request may also include a screen flow indicator identifying the present point within the navigation screen flow or hierarchy, for example, that the user is attempting to locate an address. The GPS server 133 may return reply navigation information for one or more matches. When a single match exists, flow passes along line 609 to an address page 610.

Returning to the state listing page 608, when the GPS server 133 returns more than 25 matching cities, flow passes along line 624 to a city and ZIP code data entry page 626. The GPS server 133 may convey, in the reply navigation information to the device complete address information for all of the potential matches. Alternatively, the GPS server 133 may only return in the reply navigation information a list of cities from which the user chooses. After the user enters the city and ZIP code of the POI, the device transmits the city and zip code and the GPS server 133 returns the reply navigation information for one or more matches.

At the state listing page 608, when the GPS server 133 returns more than 1 and fewer than 25 matching cities, the list of cities 628 is displayed for the user to choose between. Next flow passes to page 630 where a list of potential matching addresses is shown. Once an address is selected from page 630, flow passes along line 632 to address page 610. The address page 610 presents the individual POI address 612, a distance to the POI 614 and an estimated time of arrival (ETA) 616. The ETA 616 is calculated from the present time based upon known travel patterns and route information associated with the roadway network between the device's present location and the POI. The address page 610 also offers a GO option 618, a SAVE option 620 and a NEARBY option 622. When the GO option 618 is selected, the device transmits a navigation information request to the GPS server 133, requesting that a route calculation be performed to identify a route between the present location of the device and the selected POI. When the SAVE option 620 is selected, the device transmits a waypoint management instruction to the GPS server 133 and/or third-party account manager 135 instructing that the selected POI be saved as a waypoint in the individual user's account. When the NEARBY option is selected, the device transmits a navigation information request to the GPS server 133 requesting map data for a roadway network surrounding the selected POI.

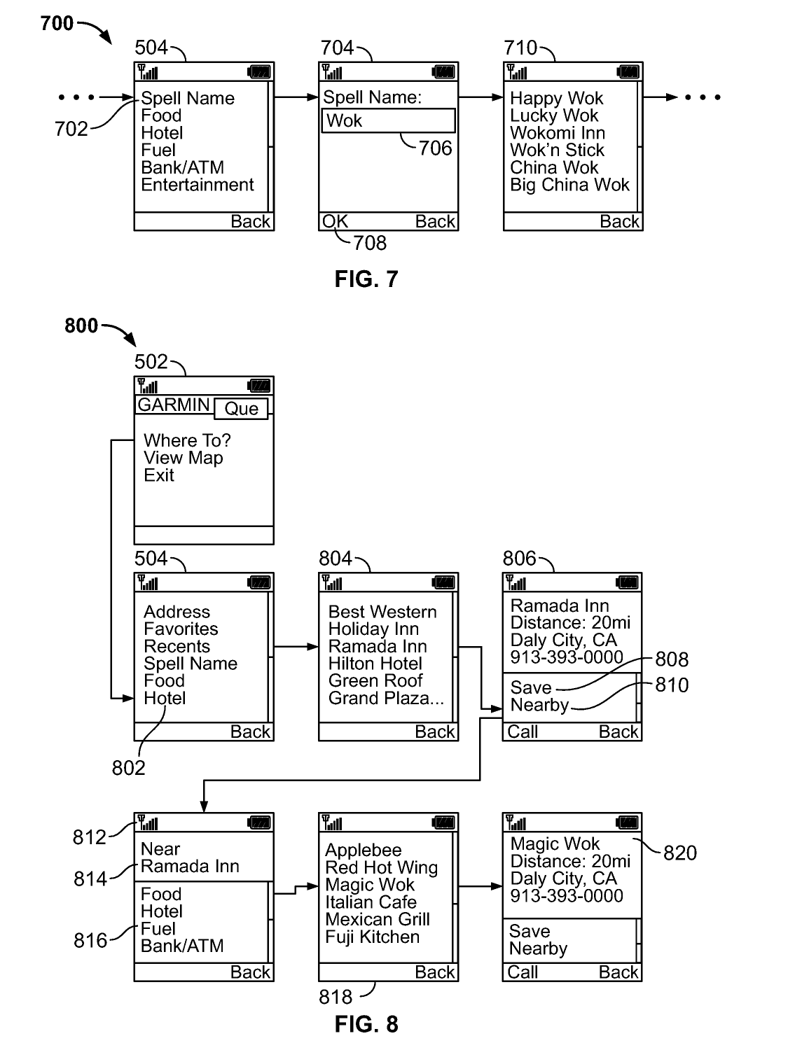

FIG. 7 illustrates a menu hierarchy 700 for locating a particular point of interest by spelling its name. Beginning at the category page 504, the SPELL NAME option 702 is selected. A spell name page 704 is presented with a text box 706 in which the user enters (via the keypad) all or part of the name of a point of interest. Once the name is entered in text box 706, the OK option 708 is selected. In accordance with one option, the device may already store in its internal memory 442 (FIG. 4) a list of points of interest, from which the processor 436 identifies matching points of interest. A name list page 710 presents potential matching points of interest. When the device does not already include a list of potential points of interest in memory 442, upon entry of the name in text box 706, the device constructs a navigation request that is transmitted over the wireless link 125 (FIGS. 1 and 2) and routed to the GPS server 133. The GPS server 133 accesses the POI database 143 and returns a list of names matching the potential point of interest. The list of potential matches are returned as reply navigation information and presented on the page 710. The list of names on page 710 may be too long to all be displayed at once. The arrow keys on the keypad are used to scroll upward and downward through the list of names on page 710. Once a matching name is selected from page 710, an address page is presented (similar to the address pages 510 in FIG. 5 and 610 in FIG. 6).

FIG. 8 illustrates a menu hierarchy 800 for performing a FIND NEARBY POI application. The user passes through the pages illustrated in FIG. 8 in order to construct a navigation request to identify a NEARBY point of interest and, in response, the GPS server 133 returns the reply navigation information related to the NEARBY point of interest. FIG. 8 flow begins at the main menu 502, from which the WHERE TO option is selected. The category page 504 is then presented and the hotel category 802 is selected. A hotel list page 804 is presented including a list of hotels that are ordered based upon the distance from each hotel to the device's present location. In the example of FIG. 8, a Best Western is the closest hotel, followed by a Holiday Inn, then a Ramada Inn, etc. When the Ramada Inn is selected, an address page 806 is displayed including the name and address of the hotel, the phone number and the distance to the hotel. The address page 806 also offers a SAVE option 808 and NEARBY option 810. The SAVE option 808 may be selected when the user desires to SAVE the hotel in the user's favorites list. The NEARBY option 810 may be selected when the user is interested in points of interest of other categories near the selected hotel.

When the NEARBY option 810 is selected, flow passes to a near-by page 812 which shows the starting point (e.g., the Ramada Inn) 814 and a category list 816. The category list 816 includes category options (e.g., food, hotel, fuel, banks/ATM, etc.). When the user picks a category option, such as food, page 818 is displayed with a list of destinations within the selected category. In FIG. 8, the destination POIs represent restaurants located near the source POI, the Ramada Inn. When the user selects a destination POI from the page 818, address details are presented on page 820 for the selected destination, namely the name and address of the location, the distance to the destination and the telephone number of the destination. In one example, the distance shown in page 820 may represent the distance between source location 814 (namely the Ramada Inn) and the destination location (namely the Magic Wok). Optionally, the distance may be between the device's present location and the chosen destination location.

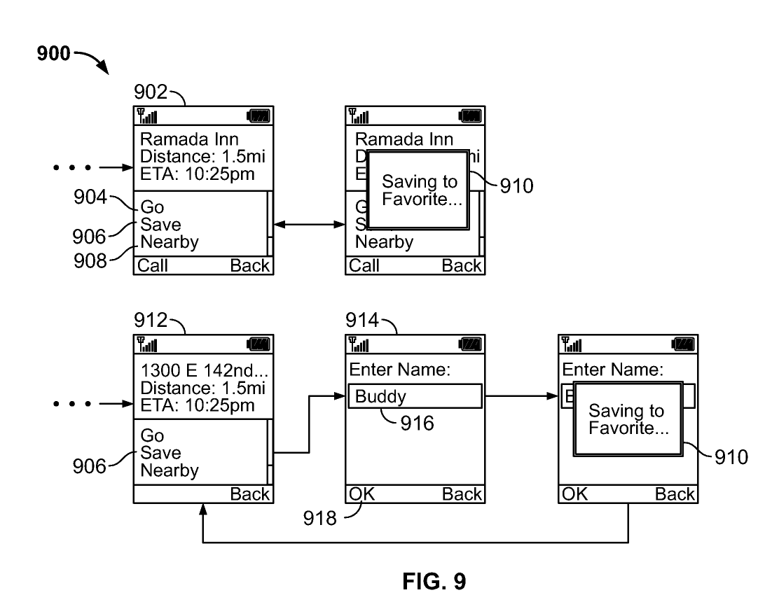

FIG. 9 illustrates a menu hierarchy 900 offered in connection with saving a particular location in a user's favorites. In FIG. 9, an address page 902 is associated with a particular destination. Page 902 offers the GO option 904, the SAVE option 906, and the NEARBY option 908. When the SAVE option 906 is selected, the device initiates a SAVE TO FAVORITES function shown by pop-up window 910. When the SAVE TO FAVORITES operation is carried out, the device constructs a navigation request that includes the address information for the selected point of interest (namely the Ramada Inn). The device then transmits the address information along with an instruction indicating that the user desires the point of interest to be saved to the user's favorites. Upon receiving the navigation request, the GPS server 133 and/or the third party account manager 135 records the address of the Ramada Inn in the favorites account for the user.

FIG. 9 illustrates an alternative screen flow carried out in connection with saving a point of interest to a user's favorites. Beginning at page 912, a particular address has been identified. When the user selects the SAVE option 906, a name page 914 is presented prompting the user to enter into text box 916 a name associated with the selected address. Once the name is entered and the OK option 918 is selected, the device initiates a SAVE operation as denoted by pop-up window 910. The SAVE TO FAVORITES option is carried out by the device transmitting, within a waypoint management instruction, the name and address to be saved in the user's favorites as a waypoint on the waypoint list. The GPS server 133 and/or third party account manager 135 save the address and name entered by the user within the user's favorites account on the user's individual waypoint list.

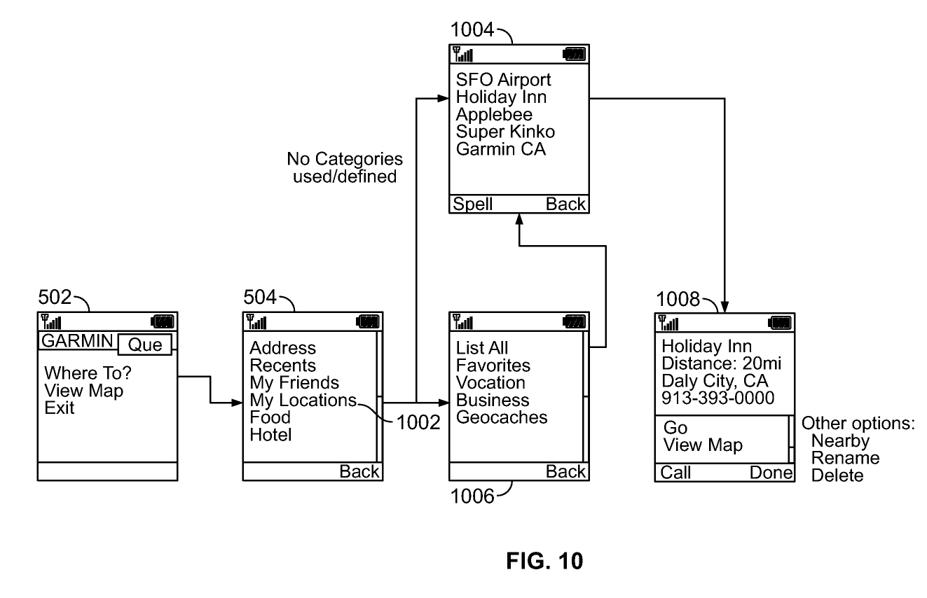

FIG. 10 illustrates a menu hierarchy presented in connection with finding a particular location based on the user's individual list of waypoints or points of interest. Beginning at the main menu 502, flow passes to the category menu 504, at which the “my locations” option 1002 is selected. Two page options are then available, depending upon the structure of the user's list of favorites. When the user has a single list of favorites that are not organized into sub-categories, flow passes to page 1004 in which each of the user's individual favorites are shown. Alternatively, when the user's favorites are organized into sub-categories, page 1006 is presented listing each of the sub-categories (e.g., list all, favorites, vacation, business, geo caches, etc.). In the example of FIG. 10, when the user selects the business option from page 1006, flow passes to page 1004 which shows the names of businesses saved within the user's individual location account. From page 1004, when an individual destination is selected, flow passes to the address page 1008.

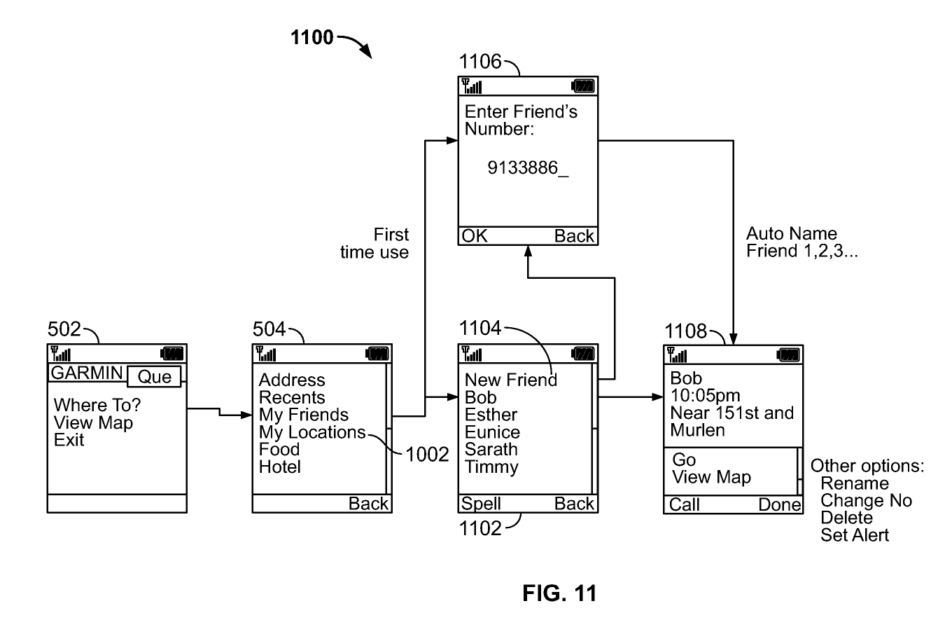

FIG. 11 illustrates a menu hierarchy 1100 offered in connection with performing a FIND FRIEND operation. Flow passes from the main menu 502 to a category menu 504, from which a MY FRIENDS option is selected. When the user's account already includes a list of friends, flow passes to page 1102 which presents the names of the friends stored in the MY FRIENDS category for the individual user. Page 1102 includes a NEW FRIEND option 1104 that may be selected when the user desires to add another individual to the list. At page 504, when the MY FRIENDS option is selected for the first time, flow passes to page 1106. At page 1106, the user enters the appropriate information about the individual, such as telephone number, name, address and the like. When the NEW FRIEND option 1104 is selected from page 1102, flow also passes to page 1106 for the entry of a new individual. Next, flow passes to page 1108 from either of pages 1102 and 1106.

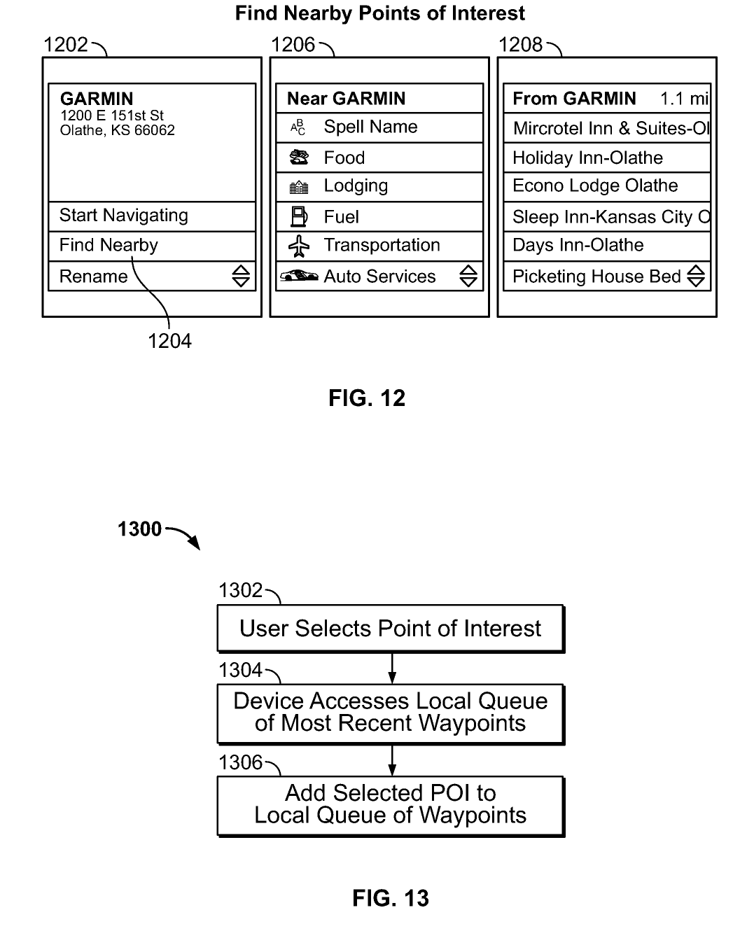

FIG. 12 illustrates a series of pages that may be presented in connection with finding near-by points of interest. Beginning at page 1202, the user enters a particular point of interest. Alternatively, page 1202 may be achieved through various of the above described processing sequences. Once a particular address is identified, such as displayed in page 1202, the user may select a FIND NEARBY option 1204, from which flow passes to page 1206 listing various categories of points of interests near the source location. Alternatively, page 1208 may be presented displaying various points of interests (such as within a single category, e.g., lodging) that are within a select distance of the source location.

FIG. 13 illustrates a flow chart of a processing sequence 1300 carried out by the processor 436 of the device 140 or 200 when a user selects a point of interest. When the user selects a point of interest at 1302, the device at 1304 accesses a local queue of the most recently stored waypoints. The queue is retained within either cache or the memory 442. At 1306, the processor 436 adds the selected points of interest to the queue of most recently selected waypoints. The queue may represent a FIFO buffer such that as new points of interest are added to the waypoint list, the oldest point of interest is written over or erased from the queue. For example, the queue may retain the ten most recently accessed waypoints. Optionally, the processor 436 may manage the waypoint queue in a more sophisticated manner. For example, the processor 436 may not duplicate points of interest in the queue. If out of the last ten waypoints, the user selects the same waypoint twice, the processor 436 may recognize the duplication in selected waypoints and not store the duplicate waypoint on the queue. Instead, at 1304, when the device accesses the local queue of most recent waypoints, the device would also compare newly selected point of interest with the existing waypoints in the queue. Processing would only move to 1306, at which the new selected POI was added to the queue, when the device determined at 1304 that the queue already did not include the selected POI.

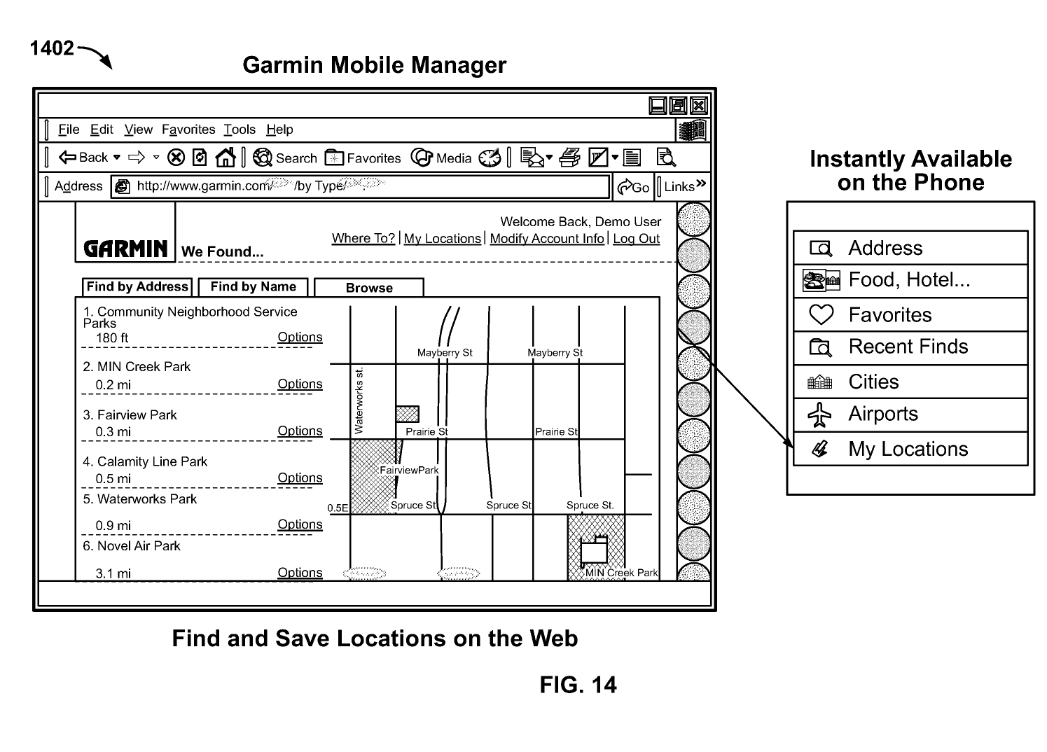

FIG. 14 illustrates a mobile manager function that may be presented, such as at a user's home PC 137 (FIG. 2). The user may access, via the home PC 137, a GPS server 133 and/or third party account manager 135 to add, delete and otherwise modify the user's individual waypoints or points of interest. In FIG. 14, a screen shot 1402 is illustrated that may be presented to the user, such as by logging on to a website maintained by GPS server 133 and/or third party account manager 135. From the home PC 137, the user may perform searches based on particular addresses or based on names. When a point of interest is identified, the user may add the location to the user's individual account of points of interest through the home PC 137. Once the new address is added to the individual user's points of interest, the POI is immediately available over the wireless device 140 for subsequent use by the user.

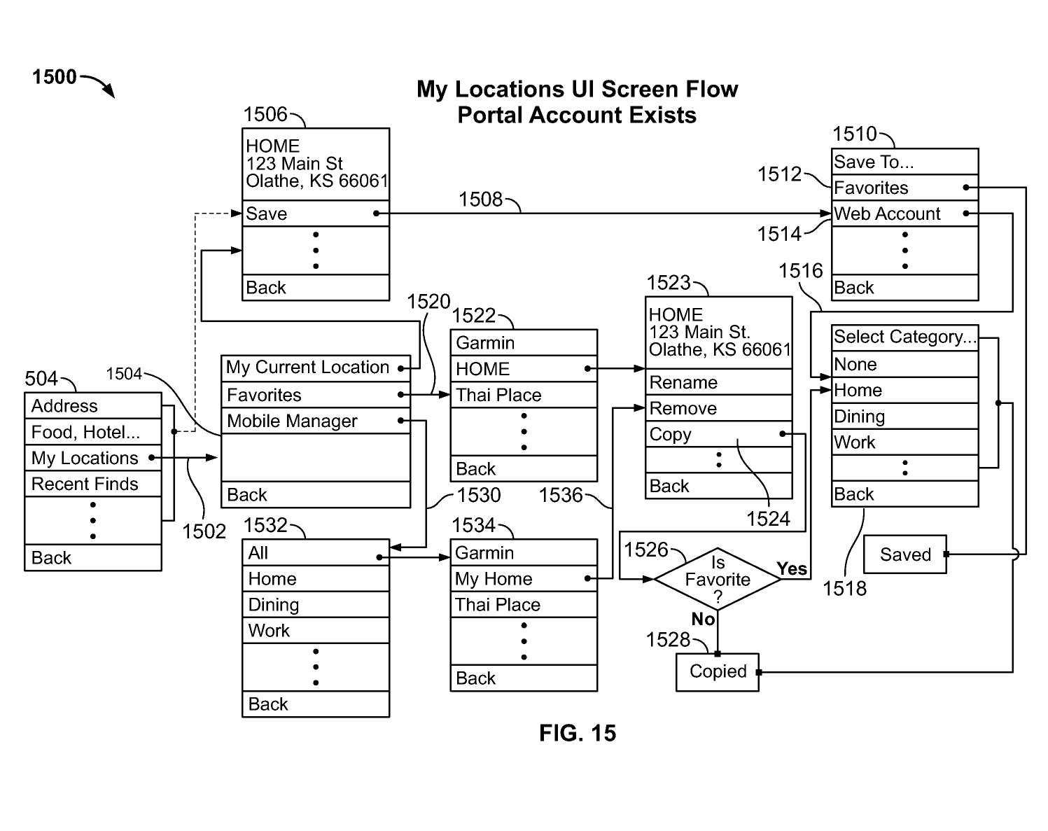

FIG. 15 illustrates a flow sequence or menu hierarchy 1500 associated with managing an individual user's waypoints or MY LOCATIONS. Beginning at the category menu 504, when the MY LOCATIONS option 1002 is selected flow passes along 1502 to a page 1504 presenting the following options, MY CURRENT LOCATION, FAVORITES and MOBILE MANAGER. When the user desires to see the current location, an address screen 1506 is presented from which the user may save the current location (see flow path 1508). When the user desires to save the current location, a page 1510 is presented offering the user the option of saving the current location to the favorites 1512 or a web account 1514. When the current location is to be saved to a web account, flow passes along line 1516, and page 1518 is presented to permit the user to save the current location within a select category (e.g., none, home, dining, work, etc.).

Returning to page 1504, when the user selects the FAVORITES option, flow passes along line 1520, after which a list 1522 of favorite saved locations is presented. When a user selects a location from the favorites, such as home, a corresponding address page 1523 is presented. The user is also presented with options at page 1523 to rename, remove and copy the location. When the user selects the copy option 1524, a decision is made at 1526 as to whether the location is already saved in the favorites. If not, the location is saved to the favorites at 1528. If the location is already saved in the favorites, flow passes to page 1518 at which the user is presented with a list of categories in which to save the address.

Returning to page 1504, when the mobile manager is selected, flow passes along path 1530 to enable the user to manage (e.g., add, delete, copy, etc.) existing favorites. Page 1532 is presented with a list of categories (e.g., all, home, dining, work, etc.), from which the user may select a sub-category to manage. In the example of FIG. 15, all of the categories are selected and thus at page 1534, a complete listing of all of the user's favorites is presented. When the user selects a particular favorite, such as the user's home, flow passes along line 1536 to page 1523. At page 1523, the user is again given the options of renaming, removing, copying and otherwise modifying the selected location or point of interest. The screen flow illustrated in FIG. 15 is presented when a portal account exists for the user on one of the GPS server 133 and third party account manager 135.

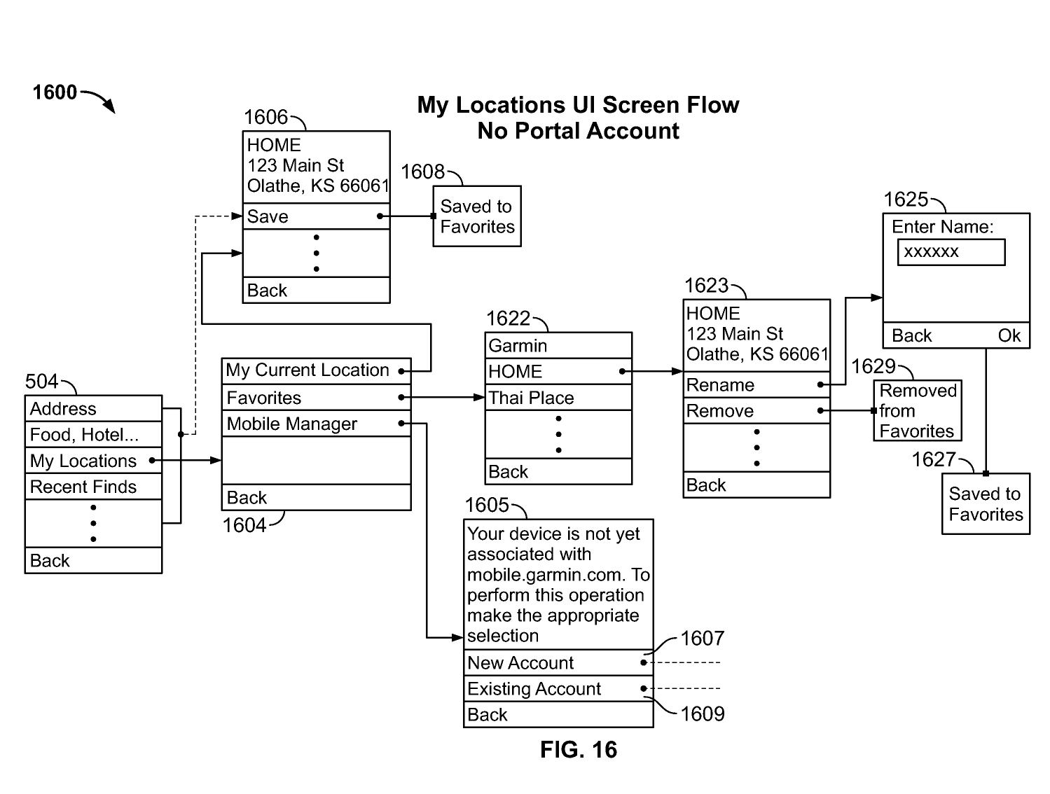

FIG. 16 illustrates an alternative screen flow 1600 that may be presented when no portal account exists. At the menu address 504, when an individual address is selected, an address screen 1606 is shown which offers the user various options, including the option to save the address. When the user desires to save the address, it is saved to the user's favorites directly at 1608. From the category menu 504, when the MY LOCATIONS options is selected, the user is again presented with a screen 1604 having MY CURRENT LOCATION option, FAVORITES option, and MOBILE MANAGER option. When the FAVORITES option is selected, a list of favorites is presented at screen 1622. When one option from the favorites screen 1622 is selected, the corresponding address is presented at page 1623 and the user is afforded the ability to rename, remove and otherwise modify the address. When the RENAME option is selected, a text entry screen 1625 is presented in which the user may enter a new name for the address. After the new name is entered, the address is saved to the favorites at 1627. At page 1623, when the user selects the REMOVE option, flow passes to 1629 where the address is removed from the favorites.

Returning to page 1604, when the mobile manager is selected, an account manager screen 1605 is presented indicating that the device is not yet associated with the GPS server 133 and/or a third party account manager 135. The user is then presented with the option of opening a new account at option 1607 or logging in to an existing account at 1609. The new or existing account is then created based upon follow-up questions and data entry by the user at the device.

In accordance with the above illustrated screen flow and hardware and software, the user is afforded the options of storing desired locations or waypoints locally on the device in the local memory 442 within a local favorites memory section. Alternatively, the location or waypoints may be stored remotely in a user account stored on a dedicated navigation server, such as the GPS server 133. As a further option, the user may establish an account with a third party account manager 135 (e.g., YAHOO, AOL, MSN, etc.) and store the locations or waypoints on the account maintained by the third party account manager 135. The stored locations or waypoints on a server are placed in user defined categories (such as business, personal, home, etc.). The categories are displayed in various menus and screens on the phone and are reproduced at the website of the third party maintaining the account and/or the GPS server website.

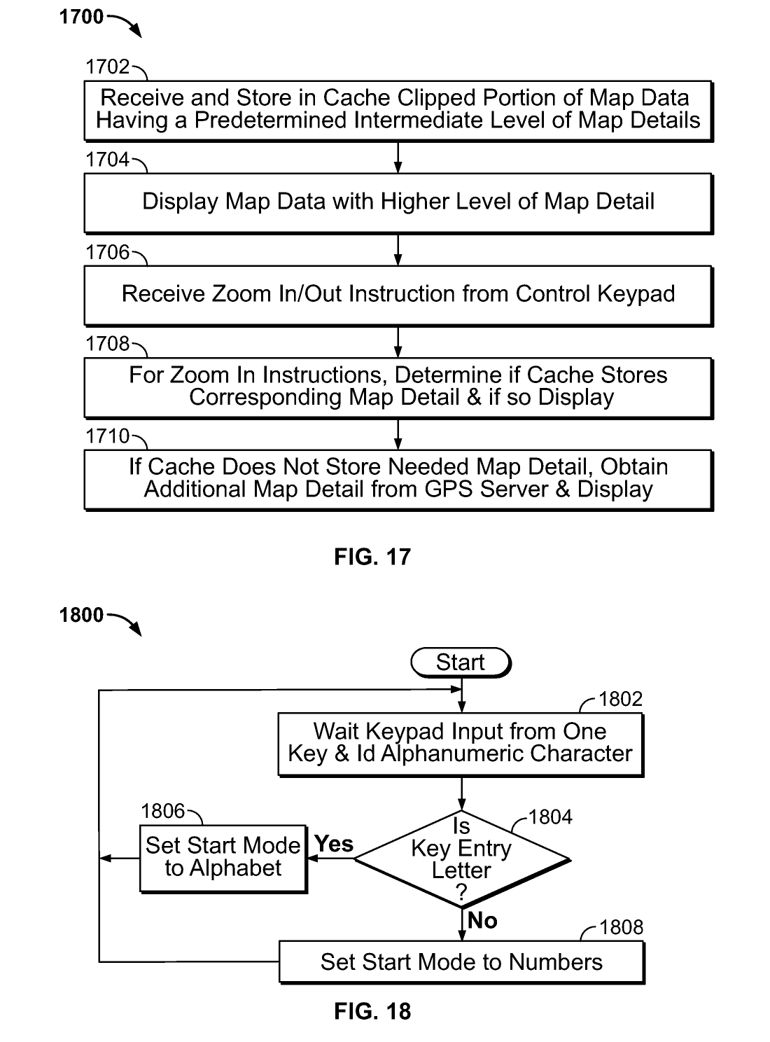

FIG. 17 illustrates an exemplary flowchart 1700 for a process carried out by the device 140 or 200 in connection with managing data storage within cache on the device while displaying mapping data. Beginning at 1702, the device receives navigation information that includes a clipped portion of the cartographic map (e.g. local map data). The local map data includes roadway network information. The roadway network information stored in the original cartographic database at the GPS server 133 includes a significant amount of low level detail for the features of the roadway network, such as node to node information, route information, intersection information, traffic pattern information, route classifications, points of interest, and the like. The local map data for a region of interest may include, at the lower level(s), more information than may be stored at one time in the cache of the device due to memory constraints. Thus, when the local map data is transmitted to the device, only a portion of the local map data may be stored in the cache, namely the information associated with intermediate and high level features of the roadway network. Examples of intermediate and high level features may include node information associated with interstate and major highways, as well as intersections between interstates and major highways.

At 1702, the device stores, in cache, map data having a predetermined intermediate level of map detail. The predetermined intermediate level is defined based on the capacity of the cache. Thus, a device having more cache memory may store lower level map details, while a device having less cache memory may only be able to store higher-level map details. At 1704, the device accesses an initial level of map detail from the map data and displays the map data with the selected initial (higher) level of map detail. The user may desire to view more or less map detail by zooming inward and outward, respectively. At 1706, the device receives a zoom-in or zoom-out instruction from the control keypad. For zoom-in instructions, at 1708, the device determines whether the cache stores the corresponding level of map detail. If the cache stores a level of map detail sufficient to display a map at the zoom level requested by the user, the device presents, on the display, the map data from the cache.

If the device determines that the cache does not store a sufficient lower level of map detail, processing moves to step 1710. At step 1710, the device transmits a request for navigation information to the GPS server 133. The request for navigation information includes a request for more detailed information regarding the region of interest. Upon receiving the more detailed information from the GPS server 133, the device then displays the corresponding detailed map information.

FIG. 18 illustrates a processing sequence 1800 carried out by the processor 436 when a user is entering alphanumeric characters through the keypad 115. The keypad 115 is configured similar to a keypad found on a cell phone, including keys, each of which is associated with one number and a series of letters. The sequence of FIG. 18 operates based on the premise that when a user enters a number, the next entry by the user will also, more than likely, be another number. Conversely, when a user enters a letter, the next entry by the user will also, more than likely, be another letter.

Beginning at 1802, the device waits for the user to enter a keypad input from one key. For example, the user may press one key three consecutive times to sequence through the potential options associated with the key. Once the user reaches the desired character, at 1802, the key entry is identified as either a letter or number or symbol. Once the key entry is identified at 1802, flow passes to 1804, at which the processor 436 determines whether the key entry represented a letter. When the key entry is a letter, flow moves to 1806, at which the processor 436 sets the “start mode” to alphabetic characters. When the start mode is set to alphabetic characters and the user next press is a key, the first character presented to the user is an alphabetic letter assigned to such key (not a number). Thus, once a user starts to enter a word, after entering the first letter, the device will enter an “alphabetic start mode” for each subsequent letter such that the user need not first sequence through the numerals assigned to each key before reaching the letters.

At 1804, if the key entry is not a letter, flow passes to 1808, at which the “start mode” is set to numbers or digits. Thus, when a user starts to enter a telephone number or address, after entering the first number, the device will enter a “digit start mode” for each subsequent number. As a further option, the start mode may be set based on the context of the data entry or page that is presently being displayed to the user. Alternatively, the start mode may be selected based upon a previously entered word or number sequence. For example, if the user has already entered “143rd”, then the device may assume that the user will next type in some type of phrase that is alphabetic, such as “place” or “street”.

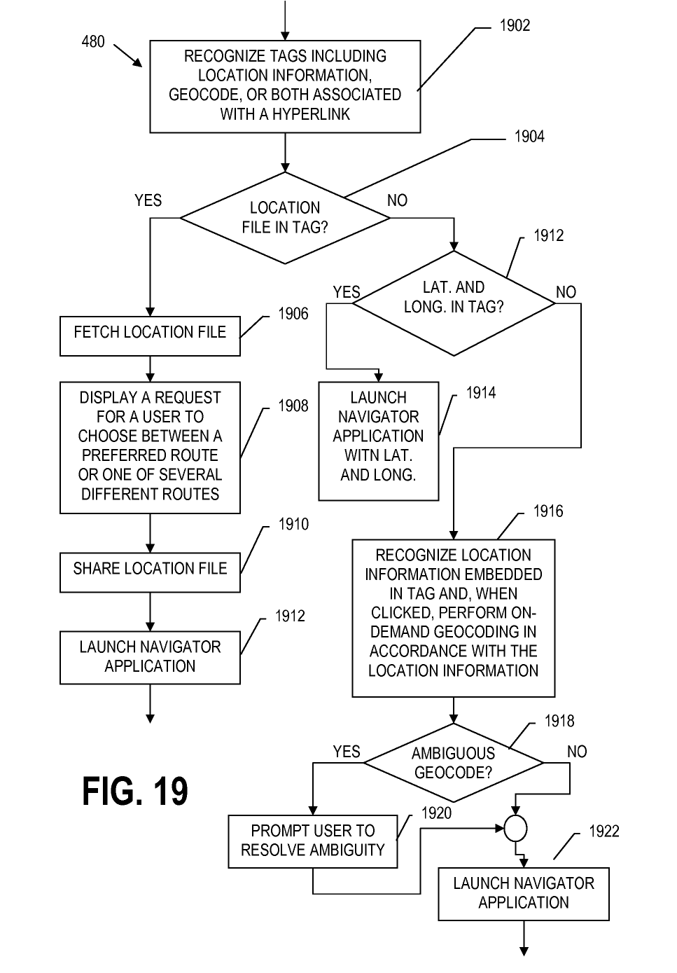

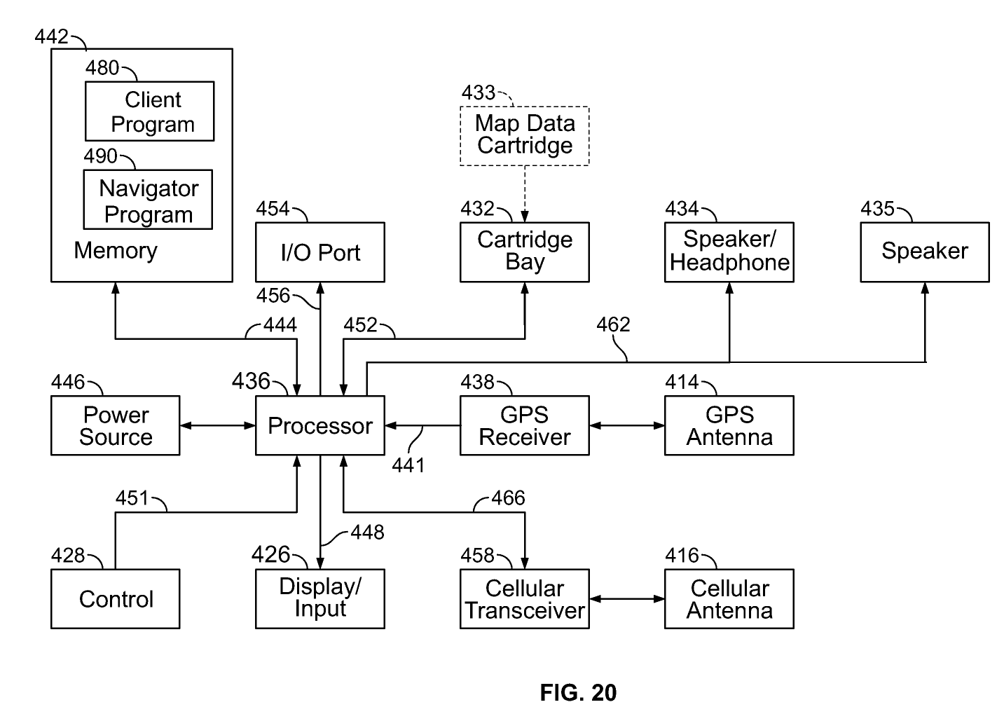

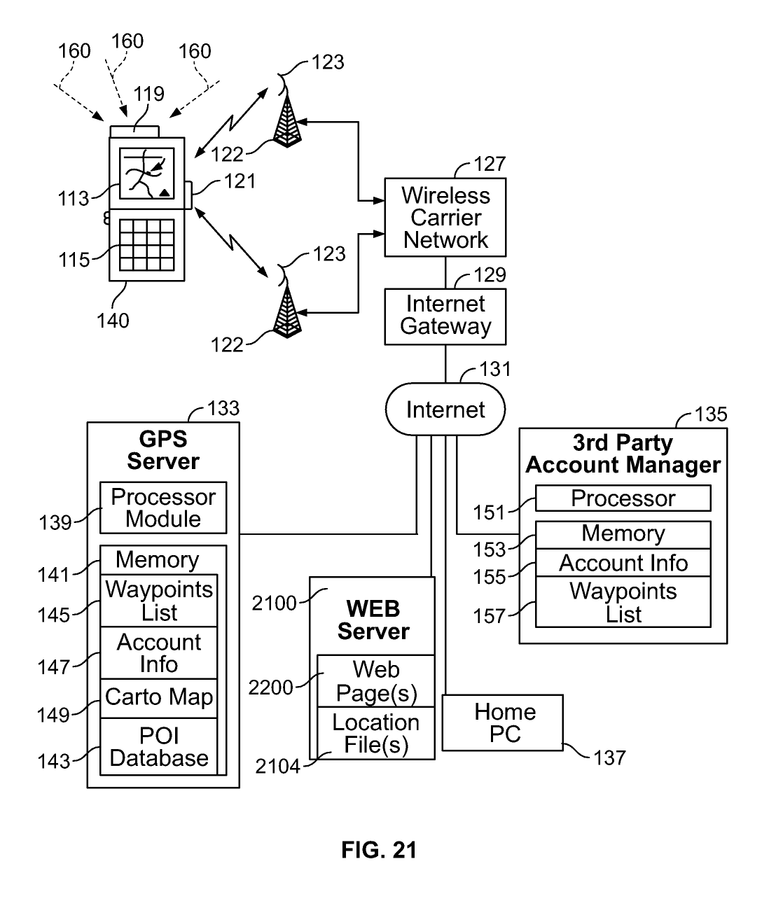

FIG. 19 illustrates a flow chart of a part of a client program 480 that can be used in some configurations of the present invention, such as GPS-enabled wireless device 140, 200, described above. FIG. 20 is a block schematic diagram of the device shown in FIG. 3 showing that client program 480 can be a web browser program stored in memory 442 of FIG. 20. FIG. 21 illustrates an additional web server 2100 communicating with the Internet 131. The web server 2100 may be a separate computer or another server program operating in the GPS server 133 or the third party account manager 135, as device 140 need not be restricted from communicating with servers other than GPS server 133. In general, the web server 2100 may be at any location, and may be a computer operated or used by anyone with knowledge of certain special tags used by the client program 480. There may also be many other additional servers operated by many different businesses and individuals, but, for illustrative purposes and without loss of generality, the embodiments described herein include only one web server 2100.

Referring now to FIG. 20, the client program 480 is stored in the memory 442. The processor 436 begins execution of the client program 480, either as part of an automatic initialization sequence, as a result of commands executed from another program, or as a result of a user command input from the display/input 426. While running on the processor 436, the client program 480 receives commands via the display/input 426, some of which may cause the client program 480 to instruct the processor 436 to connect to a network such as the Internet 131 to download a hypertext file containing hyperlinks. In the embodiment illustrated in FIG. 20, this connection may be accomplished via the cellular transceiver 458 and the cellular antenna 416.

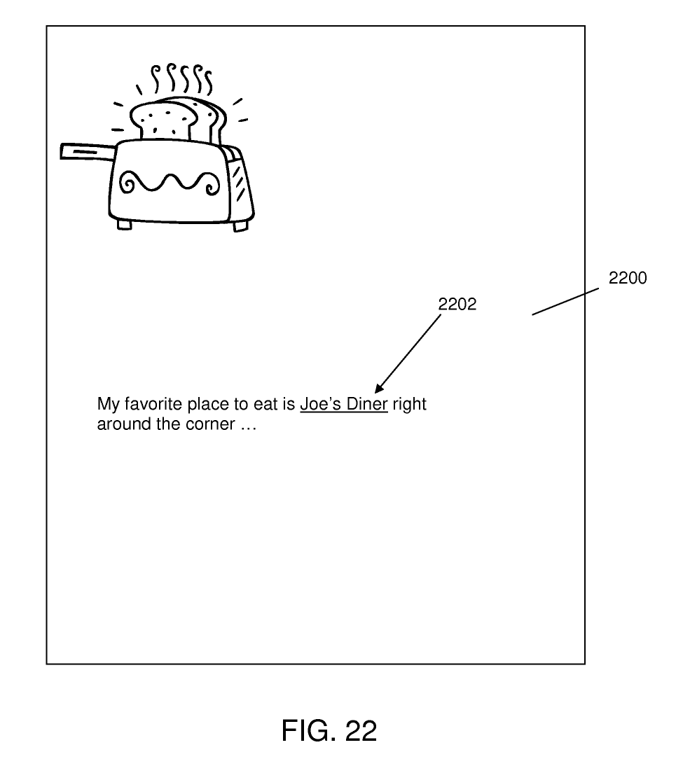

Once connected to the Internet 131 (shown in FIG. 21), web pages with hyperlinks can be downloaded by the client program 480 from a server such as the web server 2100 in FIG. 21 or the GPS server 133. Hyperlinks are commonly used in hypertext markup language (HTML) and other markup languages, and can be used in configurations of the present invention to further enhance features of a wireless portable device such as the device 140 or the device 200. FIG. 22 is a representation of a rendered web page 2200 containing an example of a hyperlink 2202. The client program 480 interprets the web page 2200 and instructs the processor 436 how to display the web page 2200 on the display/input 426 of FIG. 20, which corresponds to the screen 113 of FIG. 2 or the screen 204 of FIG. 3. The hyperlink 2202 includes a “tag” that the client program 480 knows how to interpret. Clicking or otherwise selecting and activating the hyperlink 2202 can result in actions that may include the opening of a navigator application or program 490 (represented in FIG. 20), depending upon the type of tag and any attributes associated with the tag.

Location information and/or geocode can be associated with the hyperlink 2202 in various ways. For example, suppose the client program 480 is a web browser, and an item displayed by the web browser is “My favorite place for lunch is Joe's Diner right around the corner . . . ” where “Joe's Diner” is a “location” hyperlink. In an exemplary configuration, a markup syntax with a location file 2104 (shown schematically in FIG. 21) as an attribute is indicated below. (In many configurations of the present invention, tags and attributes are not visible to a user in a displayed hyperlink 2202, but are recognized by the client program 480 and may influence the manner in which text or images are rendered.)

<text>My favorite place for lunch is <link loc=“joesdiner.loc”>Joe's Diner <end link>right around the corner . . . <end text>

The name of location file “joesdiner.loc” is embedded in the above example. These attributes are known as “tags.” Referring again to the partial flowchart of the client program 480 in FIG. 19, some configurations of the present invention recognize tags that include location information and/or geocode at 1902 when a user selects (“clicks on”) a displayed hyperlink 2202 containing such a tag. At 1904, some configurations of the client program 480 make a decision as to whether there is a location file name embedded as a hypertext attribute in the selected hyperlink such as the hyperlink 2202 in FIG. 22. If so, then the client program 480 fetches the location file “joesdiner.loc” 2104 (shown schematically in FIG. 21) from the web server 2100 at 1906. (If another location for the location file is specified, the client program 480 may fetch location file 2104 from another server.) Because attributes representing location files are recognized by the client program 480, the client program 480 will interpret the contents of the location file 2104 to provide specialized features and/or make decisions concerning which navigation features to provide. For example, at 1908, the client program 480 may display a request for a user to choose a preferred route or one of several different routes to Joe's Diner. Depending on the choice made, the client program 480 may, at 1910, mark the downloaded location file as sharable with other applications and/or other devices.

Information in a downloaded location file 2104 can include multiple via points that lead to a destination as well as options for multiple routes to a destination. For example, depending upon data in the location file 2104, a choice can be offered by the client program 480 to allow a user to select a scenic route to Joe's Diner or a fastest route. The location file 2104 may also include multiple destinations in a predetermined sequence, allowing the client program 480 to offer special routes. For example, the client program 480 may display text that reads, “Here is a one day route that lets you explore Chicago in one day”, where “one day route” is a hypertext link that includes a tag that points to a file that contains a plurality of Chicago's visitor attractions.

If the location file 2104 is marked as sharable, it may be emailed or otherwise transferred to another device or shared with or transferred to another application. The devices or programs that may be allowed to share the location file may depend upon the operating system of wireless portable device 140 or 200. For example, in some configurations, location files 2104 may be sent around and/or embedded in a document, and, when clicked, cause the client to launch a navigator application 490 to provide its various functions.

After the location file is marked as sharable at 1910, if desired, a navigator application 490 is launched at 1912. If a route was chosen at 1908, information corresponding to the selected route is used by the navigator application 490 running on the processor 436 to calculate and display a route and/or navigation directions on the screen 113 or 204 of the wireless portable device 140 or 200, respectively. For example, a route from a current location of the user to Joe's Diner through a list of waypoints corresponding to the route selection may be calculated by the navigator application 490 and the resulting route may be displayed. Otherwise, another route calculation method may be used. For example, a final destination point specified in the location file may be used by the navigator application 490 to calculate a route to the final destination point from the current position of the user.

If there is no location file 2104 specified in the tag at 1904, there may be an actual latitude and longitude embedded as an attribute in the tag. An example of a tag having an embedded latitude and longitude is printed below.

<link lat=“42.3423” lon=“−88.4452”>Joe's Diner <end link>

The client program 480 checks for an embedded latitude and longitude, or another coordinate scheme, at 1912. If a latitude and longitude are embedded, the navigator application 490 is launched at 1914 with the latitude and longitude attribute in the tag passed to the navigator application 490 so that the navigator application 490 can instantly locate the point of interest.

If the client program 480 finds no embedded latitude and longitude at 1912, another type of location information may be embedded in the attribute. An example of a tag with embedded location information is printed below:

<link loc=“14163, RIDGEVIEW, OLATHE, KS, 66062”>Joe's Diner <end link>

When a user clicks on such a link, either the client program 480 or the server 2100, 133, or 135 can perform on-demand geocoding at 1916 according to the embedded location information. In the event the location information is ambiguous at 1918, the client program 480 prompts the user at 1920 to select a possible match. For example, if the embedded location information includes “Ridgeview”, the prompt may ask the user to select “West Ridgeview or East Ridgeview.” In some configurations, a navigator application is launched at 1922 with either unambiguous geocode from 1918 or the disambiguated geocode from 1920 to enable the navigator application to locate the point of interest.

Instructions corresponding to the flow chart shown in FIG. 19 may be stored in a memory of a wireless portable device such as those described in detail herein, as well as various other wireless portable devices such as personal digital assistants (PDAs), laptop computers, palmtop computers, or any of the various types of cellular telephones. Subsets of the inventive functionality described herein for individual embodiments may usefully be employed to produce additional embodiments of the present invention. In addition, subsets of the inventive functionality described herein for individual embodiments or the entire functionality of the individual embodiments may usefully be combined with subsets of the inventive functionality described herein for other embodiments or the entire functionality of other embodiments to produce even more embodiments of the present invention.

While the invention has been described in terms of various specific embodiments, those skilled in the art will recognize that the invention can be practiced with modification within the spirit and scope of the claims.

What is claimed is:

1. A wireless portable device, comprising:
a screen;
a wireless transceiver for communicating over a wireless network with a remote server and receiving a file from the server;
a GPS receiver for receiving GPS signals from GPS satellites;
a processor connected to the wireless transceiver for controlling communication over the wireless network and connected to the GPS receiver;
memory storing software that renders the file on the screen and utilizes a tag embedded in the file along with location information based on the received GPS signals to provide navigation features.

2. The wireless portable device of claim 1, wherein the tag specifics a location.

3. The wireless portable device of claim 2, wherein the software provides a choice of routes to the location.

4. The wireless portable device of claim 2, wherein the software provides a route to the location.

5. The wireless portable device of claim 4, wherein the route is calculated by the processor.

6. The wireless portable device of claim 4, wherein the route is calculated by a GPS server located remotely from the device.

7. The wireless portable device of claim 6, wherein location information embedded in the tag and the device's current location, as determined from the received GPS signals, are sent to the GPS server through the wireless transceiver and the route is received from the GPS server through the wireless transceiver.

8. The wireless portable device of claim 1, wherein the software is configured to recognize latitude and longitude information embedded in the tag, and further configured to use the latitude and longitude information to locate a point of interest.

9. The wireless portable device of claim 1, wherein the software is configured to recognize location information embedded in the tag, and, when a user clicks on a corresponding link, to perform on-demand geocoding in accordance with the embedded location information.

10. The wireless portable device of claim 9, wherein the software is configured to prompt the user in the event the embedded location information is ambiguous.

11. The wireless portable device of claim 10, wherein the software is configured to present a list of possible matches as options when prompting the user.

12. The wireless portable device of claim 1, wherein the page displayed on the screen includes a link associated with the tag and the software is configured to recognize location information embedded in the tag.

13. The wireless portable device of claim 12, wherein the software provides a route to a location specified in the tag when a user selects the link.

14. The wireless portable device of claim 12, wherein the software provides a choice of routes to a location specified in the tag when a user selects the link.

15. A wireless portable device, comprising:
a screen;
a wireless transceiver for communicating over a wireless network with a remote server and receiving a file from the server;
a GPS receiver for receiving GPS signals from GPS satellites;
a processor connected to the wireless transceiver for controlling communication over the wireless network and connected to the GPS receiver;
memory storing software that renders the file on the screen and utilizes a tag embedded in the file along with location information based on the received GPS signals to provide a route from a current location to a location specified by the tag.

16. The wireless portable device of claim 15, wherein the route is calculated by a GPS server located remotely from the device.

17. The wireless portable device of claim 15, wherein the page displayed on the screen includes a link associated with the tag and the software is configured to recognize location information embedded in the tag.

18. The wireless portable device of claim 15, wherein the software follows the route to the location specified by the tag by displaying the route on the screen and updating the displayed route as the device traverses the route.
